(19) United States
(12) Patent Application Publication
(10) Pub. No.: US 2015/0254684 A1
(43) Pub. Date: Sep. 10, 2015

(54) COLLECTING AND ANALYZING TRANSACTION DATACOLLECTING AND ANALYZING TRANSACTION AND DEMOGRAPHIC DATA TO FULFILL QUERIES AND TARGET SURVEYS

(71) Applicant: The Earnest Research Company, New York, NY (US)

(72) Inventors: Kevin Carson, New York, NY (US); Sashikanth Chandrasekaran, Belmont, CA (US); Jason McDougall, New York, NY (US)

(21) Appl. No.: 14/716,624

(22) Filed: May 19, 2015

Related U.S. Application Data
(63) Continuation of application No. 13/936,046, filed on Jul. 5, 2013.
(60) Provisional application No. 61/668,930, filed on Jul. 6, 2012.

(51) Int. Cl. G06Q 30/02; H04L 29/08

(52) U.S. Cl. CPC G06Q 30/0201; H04L 67/306

(57) ABSTRACT

A system and method to gather and analyze transaction records and demographics associated with a plurality of consultants is presented herein. A consultant is a user that creates a profile and provides access to one or more accounts at one or more financial institutions and/or demographic data. Transaction records collected from the one or more accounts are stripped of personally identifying data, analyzed, associated with a consultant's profile, and persistently stored. Demographic data may be collected from a consultant and/or derived from the consultant's transaction records, associated with the consultant's profile, and persistently stored. Surveys are targeted at consultants based, at least in part, on the transaction records and/or demographic data associated with each consultant's profile. Furthermore, database queries are fulfilled based on the transaction records and demographic data associated with one or more consultant profiles stored in the database.

### CROSS-REFERENCE TO RELATED APPLICATIONS; BENEFIT CLAIM

This application is continuation of application Ser. No. 13/936,046, filed Jul. 5, 2013, which claims the benefit of U.S. Provisional Application No. 61/668,930, filed Jul. 6, 2012; the entire contents of application Ser. No. 13/936,046 and U.S. Provisional Application No. 61/668,930 are hereby incorporated by reference as if fully set forth herein.

### FIELD OF THE INVENTION

The present invention generally relates to collecting and analyzing transactional and demographic data, and more specifically to fulfilling queries and targeting surveys based on transactional and demographic data collected and analyzed. SUGGESTED ART UNIT: 2447; SUGGESTED CLASSIFICATION: 709.

### BACKGROUND

It is important for people and businesses to understand consumer spending patterns. For example, it is helpful for a company to know when consumers are switching to a competitor, or visa-versa. Similarly, a potential investor in a company may want to know if a company is doing better or worse than the company's competition.

Both people and businesses have access to incomplete information. For example, retail stores have access to transaction records for purchases made in their own stores by consumers. But, retail stores do not have access to transaction records for purchases made in their competitors' stores. Also for example, investors may have access to publicly disclosed sales data. For example, some companies publicly release quarterly reports. But, public disclosures do not contain data for most specific transactions. Furthermore, private companies usually need not publicly release transaction records.

Some card processors (e.g. credit card companies), which process many of the consumers' transactions, may maintain transaction records for their users. But, card processors are restricted by their retail partners from disclosing sales data of individual companies. Further, it is common for users to make use of many credit cards. Consequently, any individual credit card company would only know of a fraction of the transactions of any individual user.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a process for gathering and analyzing a consumer's spending patterns, according to an embodiment.

FIG. 2 illustrates a process for inviting customers to create consultant profiles, according to an embodiment.

FIG. 3 illustrates a process for obtaining credentials to access transaction records from one or more financial institutions, according to an embodiment.

FIG. 4 illustrates a process for selecting a connector, according to an embodiment.

FIG. 5 illustrates a process for associating transaction records with merchants and categories, according to an embodiment.

FIG. 6 illustrates a process for determining a consultant's geographic location based, at least in part, on transaction records, according to an embodiment.

FIG. 7 illustrates a webpage form for collecting credentials for a selected card, according to an embodiment.

FIG. 8 illustrates a block diagram of a storage and query system connected to, consultant computers, connectors, and financial institutions, according to an embodiment.

FIG. 9 is a spreadsheet illustrating the distances between three merchants, each of which having multiple locations, according to an embodiment.

FIG. 10 illustrates a computer system upon which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As discussed above, merchants (those that sell goods and/or services) and payment processors do not release transaction records. A consumer, however, may release the consumer's transaction records, and many may be willing to do so as long as the consumer remains anonymous. For example, a consumer that bought ten gallons of milk from a particular merchant is usually not concerned whether the world knows that someone bought ten gallons of milk from the particular merchant, as long as the consumer is not specifically identified.

A system and method to gather and analyze transaction records and demographics associated with a plurality of consultants is presented herein. For the purpose of explanation, the term “consultant” is used herein to refer to a user that provides access to one or more accounts at one or more financial institutions and/or demographic data. Financial institutions include banks, credit/debit card issuers, securities firms, or any other entity that holds cash or cash equivalents, or offers credit, for one or more persons, natural or otherwise.

According to one embodiment, a profile is established for each consultant, and transaction records are collected from the one or more accounts of the consultant. These transaction records are stripped of personally identifying data, analyzed, associated with a consultant's profile, and persistently stored.

Demographic data may be collected from a consultant and/or derived from the consultant's transaction records, associated with the consultant's profile, and persistently stored. Surveys are targeted at consultants based, at least in part, on the transaction records and/or demographic data associated with each consultant's profile. Furthermore, database queries are fulfilled based on the transaction records and demographic data associated with one or more consultant profiles stored in the database.

Consultants may be targeted to take part in surveys based, at least in part, on demographic data and transaction records associated with each consultant. For example, an owner of a particular store may target consultants in a particular geographic region, that have shopped at the particular store at some point over the past year, to survey whether people think checkout lines are too long. Also for example, an owner of a particular store may target consultants that have spent over $1,000 last fiscal year at the particular store, zero dollars in current fiscal year at the particular store, and over $1,000 in the current fiscal year at a particular competitor, to survey why consultants are now shopping at the competitor.

Transaction records and demographic data associated with one or more consultants may be used to fulfill queries. For example, an investor may query the system to determine how much consultants in a particular city spend on average per visit at a particular store, compared to how much consultants in the same city spend on average per visit at the particular store's competitors. Also for example, a merchant may query the system to determine which products and services its customers frequently purchase, but which the merchant is not selling.

### General Process Overview

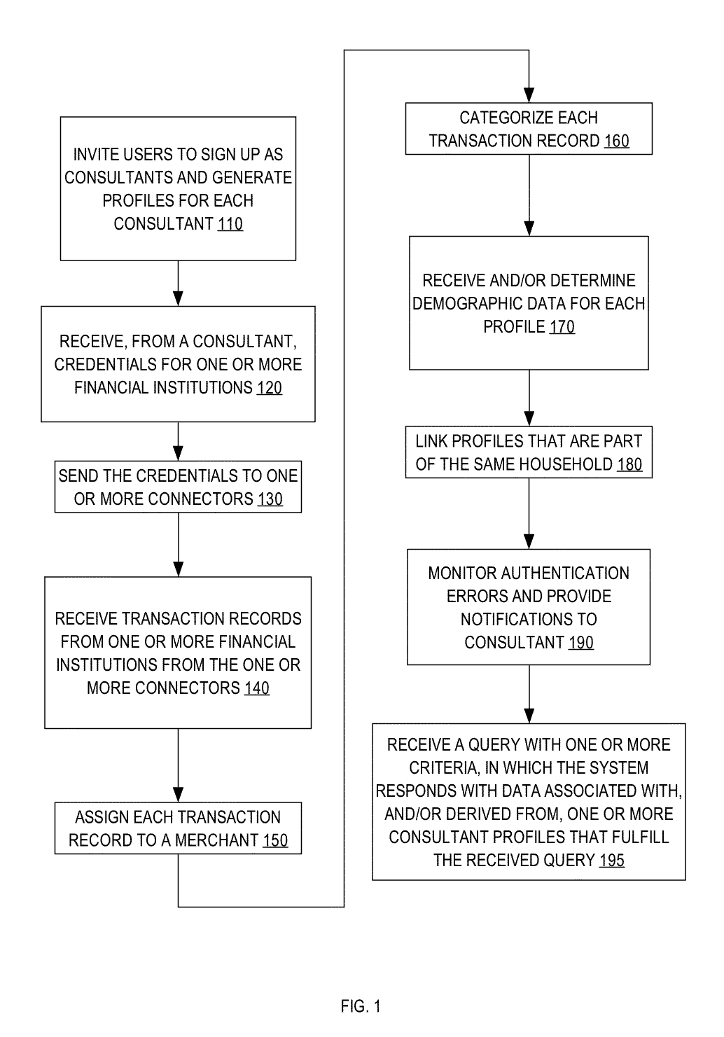

FIG. 1 illustrates a process for gathering and analyzing a consumer's spending patterns, according to an embodiment. While FIG. 1 illustrates example steps according to an embodiment, other embodiments may omit, add to, reorder, and/or modify any of the steps shown. Referring now to FIG. 1, in step 110, an invitation is given to a consumer to sign up as consultant. For example, a customer in a particular store may receive an invitation at the point of sale from a cashier to submit information, such as a username and password, to create a consultant profile through a website. Accordingly, the customer may become a consultant by submitting the information. A storage and query system (the “system”) receives the information submitted through the website from the consultant. The system creates and stores a consultant profile representing the consumer with the submitted information. The customer may be compensated in a variety of ways. For example, a customer may receive a coupon or a gift. Additionally or alternatively, as compensation a charitable donation may be made in the customer's name.

In step 120, the system receives, from a consultant, credentials for one or more accounts stored at one or more financial institutions. Continuing with the current example, the consultant may send credentials to the system, through the website, to retrieve transaction records from the consultant's bank account. Accordingly, the system receives the consultant's credentials.

In step 130, the system sends the credentials to one or more connectors. Connectors are trusted intermediaries that securely store a consultant's credentials and retrieve transaction records from one or more financial institutions using the stored credentials. For example, a connector may be a software component that interfaces with a bank to retrieve transaction records. Additionally, a connector may automatically collect banking and spending transactions for tax filings. In an embodiment, one or more connectors are third-party services, which persistently store credentials, and the system, excluding any connectors, does not persistently store credentials.

For the purpose of illustrating a clear example, assume that there is a connector with a direct connection to the bank holding the consumer's bank account. Accordingly, the system sends the credentials to the connector, which stores the credentials in persistent storage.

In step 140, the system receives transaction records from the one or more financial institutions through the one or more connectors. Continuing with the previous example, the connector may retrieve one or more transaction records associated with the consultant's bank account, using the credentials. In response to receiving the one or more transaction records, the connector returns the one or more transaction records to the system.

In an embodiment where a connector persistently stored credentials, the system need not resend the credentials to the connector to request additional transaction records associated with the consultant's back account. Continuing with the previous example, the system may periodically execute one or more processes, which may execute in parallel and/or in the background on or more server computers, and which request transaction records associated with the consultant's bank account through the connector. The connector uses the stored credentials to gain access to the transaction records associated with the consultant's bank account.

A connector need not receive a request from the system to return transaction records to the system. For example, the connector may automatically return transaction records associated with the consultant's bank account periodically, such as daily, weekly, monthly, etc. Additionally or alternatively, a connector may return transaction records to the system as transaction records are generated and stored at the financial institution.

In step 150, the system assigns one or more transaction records to a merchant. Continuing with the previous example, each of the one or more transaction records returned from the connector maybe associated with a particular merchant. A transaction record may be associated with a merchant by the financial institution the transaction record was received from, or the connector that retrieved the transaction record. Additionally or alternatively, the system associates a transaction record with a merchant based, at least in part, on a description or other data stored in the transaction record.

In step 160, the system categorizes one or more transaction records. Continuing with the previous example, each of the one or more transaction records may be associated with a category based, at least in part, on the merchant associated with the transaction record. Alternatively or additionally, a transaction record may be associated with one or more categories based, at least in part, on a description or other data stored in the transaction record.

In step 170, the system receives and/or determines demographic data for one or more consultant profiles. For example, a consultant may volunteer demographic data, such as age or age range, income level, sex, zip code, or work or home address through a webpage form, application, survey, or any other electronic data gathering tool or device. Transaction records associated with a consultant profile may be used to deduce demographic data. For example, the geographic location of a consultant may be determined based, at least in part, on transaction records associated with a consultant profile. Also for example, income levels, spending habits, and other demographic data may also be received or deduced by the system and associated with one or more consultant profiles. Additionally or alternatively, demographic data may be collected from social media profiles. The system may determine demographic data to validate demographic data volunteered by a consultant.

In step 180, the system links profiles that are part of the same household. For example, two consultants may identify each other as spouses. Accordingly, the system may associate the profiles of each consultant with the other indicating the consultants are members of the same household. Alternatively or additionally, two or more consultants may be associated with each other as members of the same household by depositing and/or withdrawing funds from the same account(s), living in the same home, or in some other way being related or dependent. The system may offer rewards to consultants for volunteering household information.

In step 190, the system monitors authentication errors while retrieving transaction records from the connectors and notifies the correct consultants accordingly. For example, a consultant may change the password required to retrieve transaction records. When the system requests transaction records, the system may be notified that authentication failed, or that additional credentials are required. In response, the system may notify the consultant and request the necessary credential information from the consultant.

In step 195, the system receives a query with one or more criteria, in which the system responds with data associated with, and/or derived from, one or more consultant profiles that satisfy the received query. For example, a query may request specific demographic data regarding consultants that shop at a competitor of a particular merchant. In response the system may return the demographic data associated with each consultant profile that satisfies the query. The demographic data may include any data associated with a consultant, such as location, income level, household size, related products and services, and/or the particular financial institutions associated with each consultant profile that satisfies the query. The demographic data need not include any personally identifying information. Alternatively or additionally, the consultant profiles are returned. For example, consultant profiles that satisfy the one or more criteria are returned. The consultants that correspond to the returned consultant profiles may be sent a survey through a website, email, text message, custom mobile application, or any other software or electronic devices, or postal service. Accordingly, consultant profiles may include data to indicate how and/or where to contact the corresponding consultant and/or send the corresponding consultant surveys.

### Structural Overview

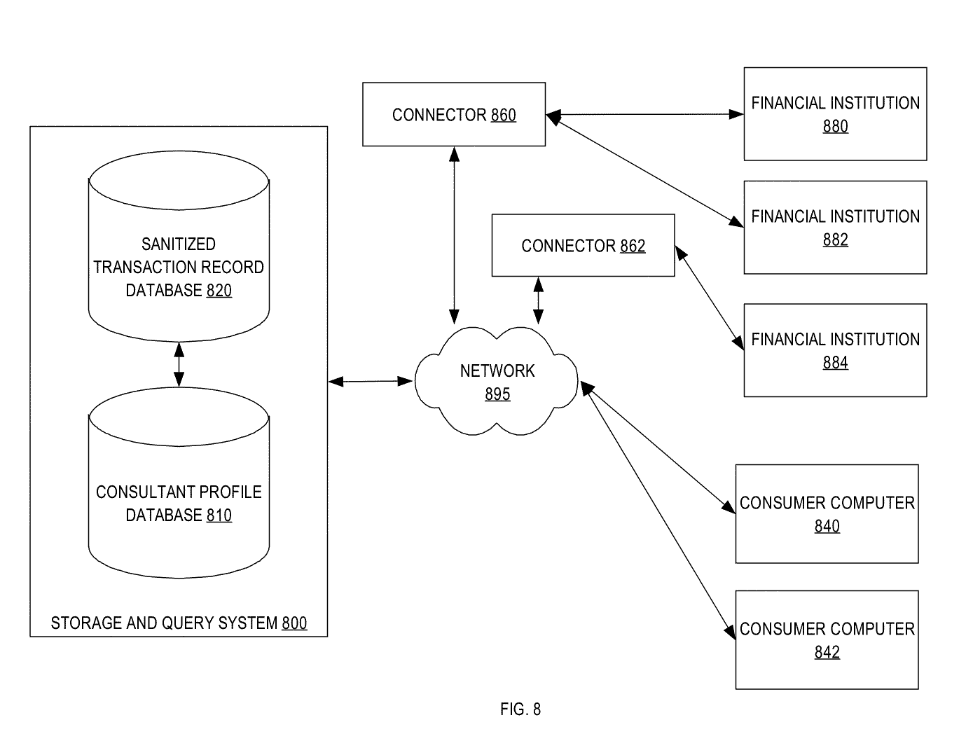

FIG. 8 illustrates a block diagram of a storage and query system connected to, consultant computers, connectors, and financial institutions, according to an embodiment. While FIG. 8 illustrates one embodiment for purposes of illustrating a clear example, other embodiments may omit, add to, reorder, and/or modify any of the elements shown.

In the embodiment illustrated in FIG. 8, storage and query system 800 includes consultant profile database 810, and sanitized transaction record database 820. Storage and query system 800, consultant profile database 810, and sanitized transaction record database 820 may refer to one or more server computers comprising one or more cores, processors, or computer clusters. Storage and query system 800 is coupled through network 895 to consumer computers 840 and 842, connectors 860 and 862, and financial institutions 880, 882, and 884. Network 895 may be a private network, a wide area network, or the Internet.

Consultant profile database 810 may be a database storing one or more consultant profiles and demographic data. For example, consumers invited to register as consultants may use a computer, such as consumer computer 840, which is coupled to storage and query system 800, to securely submit information to system 800, using one or more encryption methods, to create a consultant profile stored in consultant profile database 810. A consultant, though consumer computer 840, may submit demographic data to system 800, which is stored in consultant profile database 810. Consultant profile database 810 may also store additional information and associations, such as associations between consultant profiles and one or more connectors.

Sanitized transaction record database 820 stores transaction records, which do not contain identifying information, but are associated with one or more consultant profiles stored in consultant profile database 810. For purposes of illustrating a clear example, assume a consultant, through consumer computer 840, securely submits, using one or more encryption methods, credentials to storage and query system 800. Further assume that the submitted credentials authorize access to the consultant's account at financial institution 880. Accordingly, assume the credentials are securely sent to connector 860, which has a direct feed to financial institution 880. Still further assume that connector 860 persistently stores the credentials and securely sends the credentials to financial institution 880 in a request for one or more transaction records. In response, connector 860 retrieves the requested transaction records from financial institution 880, and returns the transaction records to storage and query system 800. Storage and query system 800 sanitize the returned transaction records, removing personally identifying information, such as account numbers, names, credit card numbers, etc. System 800 persistently stores the sanitized transaction records in sanitized transaction record database 820. Storage and query system 800 also associate the persistently stored and sanitized transactions records with the consultant's profile.

Connectors 860 and 862 are coupled with storage and query system 800 and financial institutions 880, 882, and 884. In the embodiment illustrated in FIG. 8 connectors 860 and 862 are coupled with storage and query system 800 and financial institutions 880, 882, and 884 through network 895. Additionally or alternatively, one or more of connectors 860 or 862 may be directly coupled to storage and query system 800 or one or more of financial institutions 880, 882, or 884, through some other network, such as a private network, and not through network 895, which may be a publicly accessible network such as the Internet.

### Inviting Consumers to Create Consultant Profiles

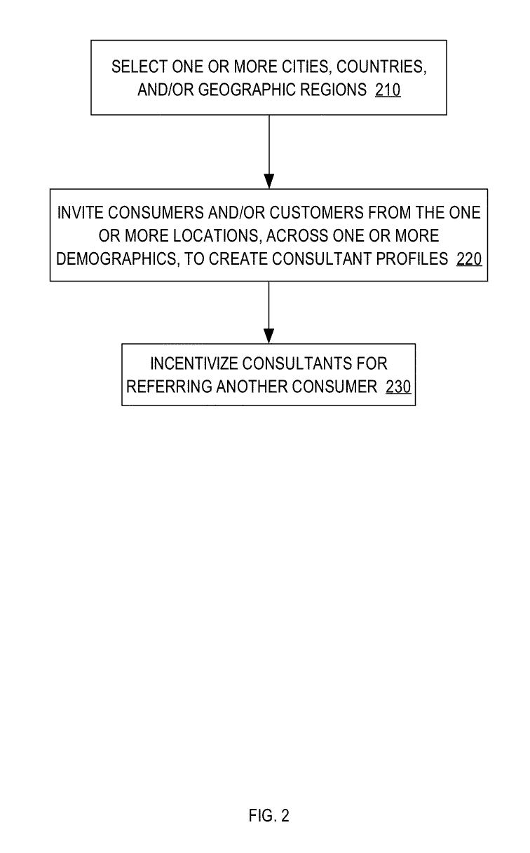

FIG. 2 illustrates a process for inviting customers to create consultant profiles, according to an embodiment. While FIG. 2 illustrates example steps according to an embodiment, other embodiments may omit, add to, reorder, and/or modify any of the steps shown. Referring now to FIG. 2, in step 210, the system selects one or more cities, countries, and/or other geographic regions. For example, large cities with a particular distribution of consumers across a plurality demographics may be selected. Additionally or alternatively, the one or more locations may be constrained by geographic areas within a maximum level of consumer density (e.g., consumers per kilometer, or consumers per mile). Additionally or alternatively, the one or more locations may be constrained to locations that have at least a threshold level of consumer density.

In step 220, the system invites consumers and/or customers from the one or more locations, across one or more demographics, to create consultant profiles. For example, consumers at, or from, the one or more selected locations may be randomly invited at a point of sale, or outside of a store, to create a consultant profile. Also for example, a consumer making an online purchase may be invited to create a consultant profile based, at least in part, on the consumer's billing or mailing address. Additionally or alternatively, consumers may be invited to create consultant profiles based, at least in part, on other demographic criteria, such as age and/or income level. Additionally or alternatively, consumers that purchase one or more particular goods or services may be invited to create consultant profiles. Additionally, invitations may include one or more incentives, such as a coupon, a gift, or a donation to a charity.

More than one consumer within the same demographic may be invited to create a consultant profile. Having more than one consultant in the same demographic may create redundancy, provide statistical significance, increase anonymity, and/or account for consultants that do not include all the data possible in their profile. For example, a plurality of the invited consumers may be in the same age group, income level, and zip code. Additionally or alternatively, the system may accept up to a maximum number of consultants in the same demographic. Additionally or alternatively, the system may not reward consumers that create consultant profiles which fall in a demographic at or above the maximum number.

In step 230, the system incentivizes consumers for referring another consumer. For example, a user that signs up, or creates a consultant profile, may be rewarded for referring other users regardless of whether the referred users fall within the same demographic as the consultant. Additionally or alternatively, consultants may be rewarded for referring users from underrepresented demographics. Additionally or alternatively, consultants may be rewarded differently for referring users from demographics other than the referrer's demographic.

In an embodiment, consumers are not invited to create consultant profiles through keyword-based advertising or display advertising. Not inviting consumers through keyword-based advertising or display advertising may reduce or eliminate selection bias.

### Acquiring Anonymous Consultants from Third Parties

Anonymous consultants and anonymous transaction records may be acquired through third parties. Anonymous transaction records are transaction records received from a third party, in which that transaction records do not include any personally identifying information. Anonymous transaction records may comprise a unique user or account identifier, a transaction description, a transaction postdate, and an amount.

Anonymous consultants are consultants with consultant profiles that are associated with anonymous transaction records. Accordingly, the system may create an anonymous consultant for each unique identifier observed in the anonymous transaction records and associate the anonymous transaction records with appropriate anonymous consultant's profile. Anonymous consultants may be treated as consultants for purposes of querying for data. Anonymous consultants need not, however, be targeted for surveys because no contact information is available for anonymous consultants.

Anonymous transaction records associated with anonymous consultant profiles, which appear to have an incomplete transaction history for a particular time period, may be ignored. For example, if an anonymous consultant's profile is associated with anonymous transaction records that have more than a one month gap over a particular amount of time, then the anonymous consultant's profile and associated transaction records may be ignored.

For purposes of illustrating a clear example, assume the system receives a query for the average amount spent per customer each month, over the past three months, at a particular merchant's store. Assume that three anonymous consultant profiles, C1, C2, and C3 are stored in the system. Assume one or more anonymous transaction records associated with C1 are present for months M1, M2, and M3. Assume one or more anonymous transaction records associated with C2 are present for months M1 and M3. Assume one or more anonymous transaction records associated with C3 are present for months M1, M2, and M3. Since C2 has a month gap without any transaction records, C2's transaction history may be determined to be incomplete. Accordingly, the system may ignore C2's profile and associated anonymous transaction records in the returned results.

In another example, assume the system receives a query for the average amount spent per customer each month, over the past three months, at a particular merchant's store. Assume that two anonymous consultant profiles, C1 and C2, are stored in the system, and that each consultant profile is associated with multiple accounts: C1 is associated with accounts A1 and A2, and C2 is associated with A3 and A4. Assume one or more anonymous transaction records associated with A1 are present for months M1, M2, and M3. Assume one or more anonymous transaction records associated with A2 are present for months M1, M2, and M3. Assume one or more anonymous transaction records associated with A3 are present for months M1 and M3. Assume one or more anonymous transaction records associated with A4 are present for months M1, M2, and M3. Since C2's A3 account has a month gap without any transaction records, C2's transaction history may be determined to be incomplete. Accordingly, the system may ignore C2's profile, C2's accounts A3 and A4, and associated anonymous transaction records in the returned results.

Additionally, the system may limit the number of anonymous consultant profiles returned, or used to compute, the results. The limit may be imposed system wide, or query by query. For example, the system may receive a query for the average amount spent per customer each month, over the past three months, at a particular merchant's store. The query may include one or more criteria that specify that the number of anonymous consultant profiles included in the query, or data associated with anonymous consultant profiles, should be limited to a particular percentage (e.g., 10%). Accordingly, in this example, of the transactions records used to fulfill the query, the associated anonymous consultant profiles may account for 10% or less of all the associated consult profiles.

### Obtaining Credentials to Access Consultant Accounts

Consultants have credentials, such as a username and password, which allow consultants to access their statements or view transaction records from one or more financial institutions. Accordingly, the system, and/or connectors, may use each consultant's credentials to retrieve transaction records from a consultant's account at a financial institution. If the credentials are persistently stored, the system and/or one or more connectors may subsequently access an account's transaction history without receiving the account's consultant's credentials each time. For example, the system, through one or more connectors, may retrieve the transaction history for each consultant daily using one the consultant's credentials stored at the one or more connectors.

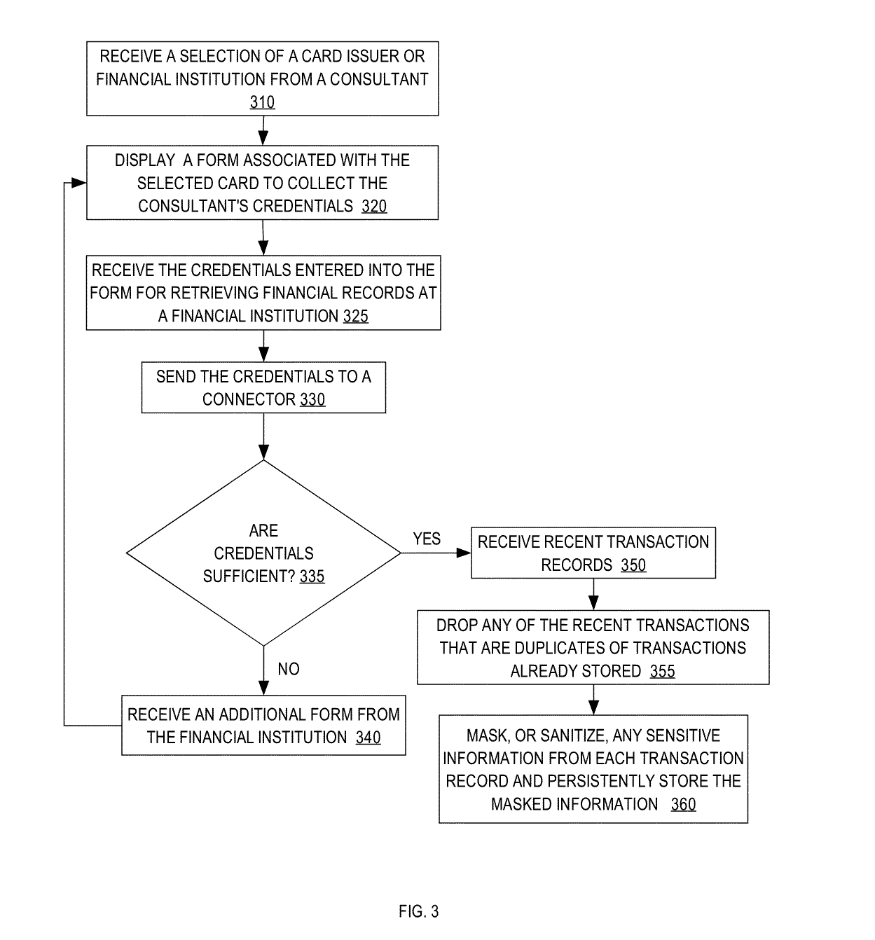

FIG. 3 illustrates a process for obtaining credentials to access transaction records from one or more financial institutions, according to an embodiment. While FIG. 3 illustrates example steps according to an embodiment, other embodiments may omit, add to, reorder, and/or modify any of the steps shown. Referring now to FIG. 3, in step 310, the system receives a selection of a card issuer or financial institution from a consultant. For example, the system may receive, through an application or website used by a consultant, a particular credit card issuer from a list of credit card issuers or other financial institutions. If the consultant uses a financial institution that is not included in the list, then the consultant may enter the name, or other identifying information, of the financial institution in a field.

The system may collect publically available statistics on the most frequently used electronic cards. The statistics may be used to determine which credit card issuers, banks, or other financial institutions to present to the user in step 310.

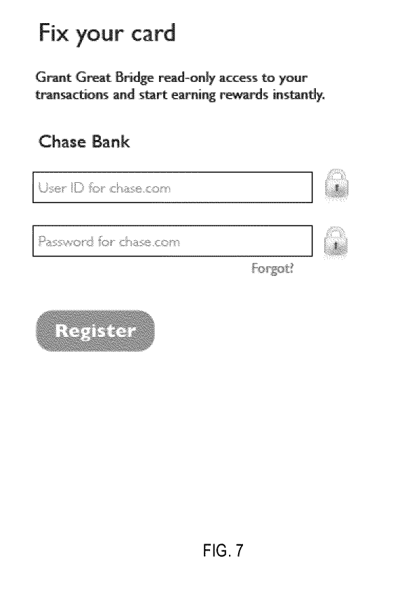

In step 320, the system displays a form associated with the selected card to collect the consultant's credentials. For example, FIG. 7 illustrates a webpage form for collecting credentials for a selected card, according to an embodiment. While the embodiment illustrated in FIG. 7 provides fields for credentials that include a username and password, other forms may include other credentials, such as email addresses, authentication keys, credit card numbers, security codes, encryption keys, birthdates, certificates, challenge questions, or any other data, to identify a particular account and/or grant access to one or more transaction records. The form may be different for each card issuer or financial institution. Additionally or alternatively, and as discussed below, a user may be presented with a form to upload a document or statement, which comprises transactions transaction records, to the system. While the form illustrated in FIG. 7 is a web page displayed in a web browser, the form may be displayed in an application running on a computer or mobile device, and/or any other electronic device that may display a form, receive input, and send the input to the system.

The system may maintain a cache of forms for one or more financial institutions, which multiple consultants hold accounts at. If a form for a selected financial institution is not cached, then the system may access the financial institution's web site, database, or other repository, to obtain a form, or obtain data to generate a form, either directly or via a connector. For example, if no form is cached for a particular financial institution selected by a consultant, the system may request a form from a connector with a direct data feed to the selected financial institution. In response the connector may return to the system a cached form, or a form scraped from the financial institution's website, to present to the consultant. After the system returns the system may cache the form and present the form to the consultant.

Additionally or alternatively, a financial institution may allow for OAuth authentication. The system may direct the user, through an application, or redirect a user from the system's website, to the consultant's financial institution's website. The consultant may authenticate with the financial institution and the financial institution may send an authentication token or hash that can be used by the system or a connector to read transaction records from the financial institution. Accordingly, upon a consultant successfully logging into the consultant's account at a particular financial institution, the financial institution may return a unique hash, which is treated as the credential. Accordingly, either the system or the connector may store the unique hash as the credential to access the account, without storing the account holder's username and password. The hash may also be used to track the account without personally identifying the account holder.

In step 325, the system receives the credentials entered into the form for retrieving financial records at a financial institution. For example, in FIG. 7, in response to a consultant entering her credentials into the form presented in step 320, and selecting the “Register” button, the credentials may be sent to, and received by, the system over a secure connection. While the embodiment illustrated in FIG. 7 is a web page displayed in a web browser, credentials may be sent or received from an application, mobile device, web service, and/or any other mechanism or electronic device that may send or receive credentials.

In step 330, the system sends the credentials to a connector. As discussed in detail below, one or more connectors may be selected and sent the consultant's credentials. The one or more connectors may store the credentials in a secure persistent storage device, used for future refreshes. For example, the consultant's credentials for a bank account may be sent to a connector as part of the system's first request for transaction records. Periodically, e.g., once a day, week, month, etc., the system may send additional requests for transaction records, through the connector, without resending the consultant's credentials to the connector. In an embodiment, the system does not persistently store the credentials.

In step 335, the system determines whether the credentials are sufficient. For example, if the credentials are sufficient, the financial institution will return recent transaction records to the connector, which the connector returns to the system. If so, control proceeds to step 350. Otherwise, control proceeds to step 340.

In step 340, the system receives an additional form from the financial institution. For example, the financial institution, through the connector, may return a form containing one or more “challenge questions” which require one or more particular responses. Accordingly, control proceeds to step 320 to display the received form requiring one or more credentials from the consultant, and steps 320 through 335 are repeated. Additionally in revisited step 320, if the additional credential is a challenge question, and if the consultant is required to also select a challenge question out of one or more challenge questions returned, the consultant may also be presented with a drop down menu, or some other visual element to select one or more challenge questions.

In step 350, the system receives recent transaction records. For example, as discussed above, in step 335, in response to the connector successfully accessing the consultant's account with the provided credentials, recent transaction records are returned to the connector, which are forwarded to the system.

In step 355, the system drops any of the recent transactions that are duplicates of transactions already stored. In an embodiment none of the consultant's credentials, including name, password, or card number, are persistently stored. In such an embodiment, it is possible for a consultant to enter credentials for an account that has already been added to the system. Accordingly, the system may check for and remove duplicate transaction records by comparing the data in each received transaction record with the persistently stored transaction records that are already associated with the consultant.

In step 360, the system masks, or sanitizes, any sensitive information from each transaction record and persistently stores the masked information from step 355. For example, the system may mask the account holder's name or credit card used to make a transaction. Furthermore, the system may filter out transactions such as direct deposits, interest accrual, and tax payments, or other records that do not contain spending data. The system may also display the masked and/or filtered transaction records to the consultant along with any rewards the consultant has earned for sharing her transaction records.

The steps above may be repeated multiple times for each consultant. For example, the steps above may be repeated for additional accounts during the same browser session with the same consultant.

### Selecting Connectors to Access Accounts

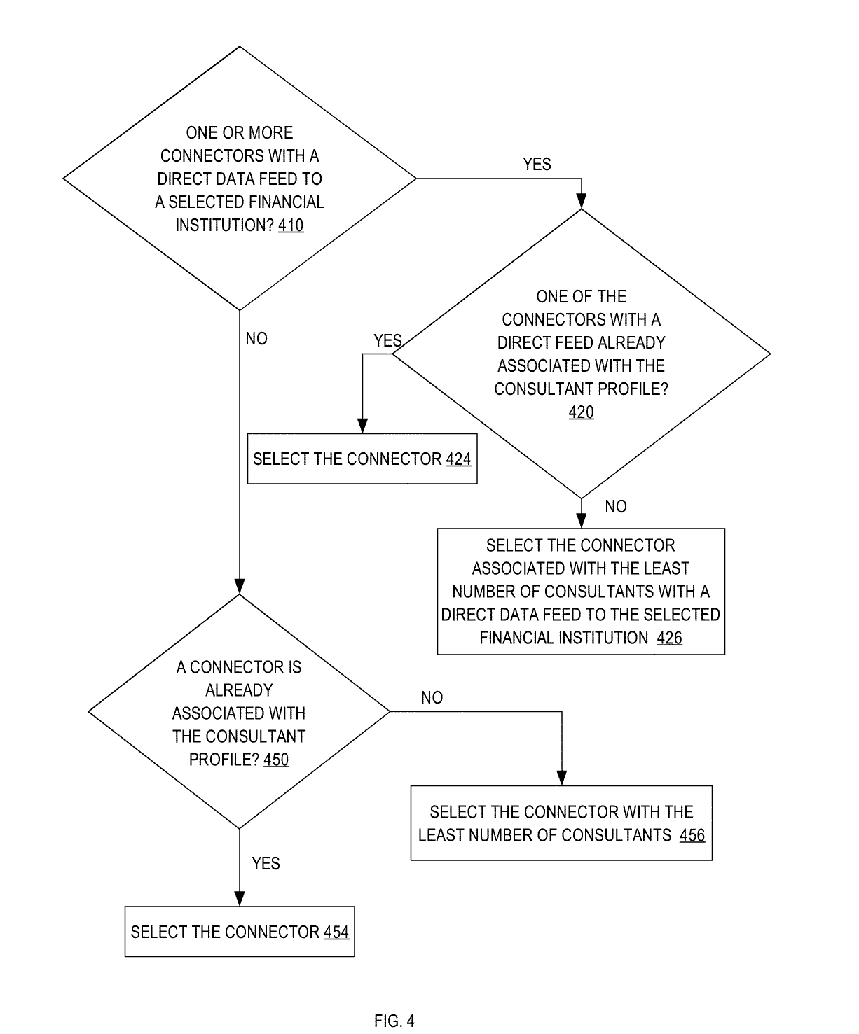

FIG. 4 illustrates a process for selecting a connector, according to an embodiment. While FIG. 4 illustrates example steps according to an embodiment, other embodiments may omit, add to, reorder, and/or modify any of the steps shown. Referring now to FIG. 4, in step 410, the system determines whether one or more connectors have a direct data feed to a financial institution. If so, control proceeds to step 420, otherwise control proceeds to step 450. For purposes of illustrating a clear example, assume the system receives credentials from a consultant for an account at a financial institution. The system determines whether one or more of the available connectors have a direct feed to the financial institution.

A direct data feed between a connector and a financial institution is a connection in which the financial institution allows the connector to access transaction records for a particular account without requiring one or more of the required credentials, which an entity that does not have a direct feed would be required to provide. For example, a financial institution may require a connector with a direct data feed to supply a username and password for a target account to retrieve transaction records associated with the target account. In contrast, a financial institution may require a connector without a direct data feed to supply a username and password for a target account, as well as an answer to a challenge question, to retrieve transaction records associated with the target account. Also for example, a connector with a direct data feed to a financial institution may have a unique hash code for an account the connector is authorized to access, e.g., an OAuth hash. Accordingly, the connector may store the unique hash as the credential to access the account, and not the account holder's username and password.

In step 420, the system determines whether one of the connectors with a direct feed is already associated with the consultant profile. If a connector is already associated with a consultant profile, then reusing the same connector minimizes the number of connectors the system needs to manage for each consultant profile. Thus, refreshing the transaction records for the consultant profile may be faster and/or simpler because fewer connectors are needed. Furthermore, the connector may already have the credentials for the particular account which the system intends to retrieve transaction records from. Accordingly, if the system determines that there is a connector with a direct feed then control proceeds to step 424, otherwise control proceeds to step 426.

In step 424, the system selects a connector already associated with the consultant profile. If more than one connector is associated with the consultant profile, then the system selects, out of the connectors with a direct feed to the financial institution and associated with the consultant profile, the connector associated with the least number of consultant profiles. For the purpose of illustrating a clear example, assume that two connectors are associated with a consultant profile and have direct feeds to a financial institution. Also assume that the first connector is also associated with 100 total consultant profiles, whereas the second connector is associated with ten total consultant profiles. The system selects the second connector since the load is likely to be greater on the first connector.

In step 426, the system selects the connector associated with the least number of consultant profiles and with a direct data feed to the selected financial institution. As discussed above in step 424, selecting the connector associated with the fewest number of associated profiles may help balance the number of requests, and the bandwidth used, for each connector. Accordingly, the system associates the connector with the least number of consultant profiles and with a direct data feed to the selected financial institution with the consultant profile.

In step 450, the system determines whether a connector without a direct feed is already associated with the consultant profile. Selecting a connector that is already associated with the consultant profile may have the same benefits discussed above in step 420. Accordingly, if a connector is already associated with the consultant profile, control proceeds to step 454, otherwise control proceeds to step 456.

In step 454, the system selects a connector already associated with the consultant profile. If more than one connector is associated with the consultant profile, then the system selects, out of the connectors associated with the consultant profile, the connector associated with the least number of consultant profiles.

In step 456, the system selects the connector associated with the least number of consultant profiles. Selecting the connector associated with the fewest number of associated consultant profiles may help balance the number of requests, and the bandwidth used, for each connector. Accordingly, the system associates the connector with the fewest number of associated consultant profiles with the consultant profile.

In an embodiment, a consultant profile is associated with a single connector at a time. In another embodiment, a consultant profile may be associated with more than one connector at a time. For example, a plurality of accounts may be associated with a consultant profile and each account may be associated with a different connector. Accordingly, if an account is already associated with a connector, then the system need not select a new connector to refresh the transaction records for that account.

### Monitoring Authentication Errors while Retrieving a Transaction Feed from Connectors

As discussed above, connectors may persistently store a consultant's credentials. Connectors may repeatedly use the consultant's credentials to continue to retrieve transaction records associated with the account on an ongoing basis. Unfortunately, at some point a connector may no longer access an account for which it has credentials for. For example, a consultant may change his/her credentials to access the account. Also for example, the financial institution at which the account is held may issue a new challenge question. In still another example, the financial institution at which the account is held may require credentials to be updated periodically.

In response to detecting that a connector is no longer authorized to access an account for a consultant, the system may notify the consultant. For example, the system may send the consultant an email. If the system detects that authentication failed because the consultant's account password changed and/or because the financial institution issued a new challenge question, then the system may ask the consultant for the required credentials through an application or a website. For example, the system may repeat the steps with the consultant discussed in FIG. 3 above.

Additionally, the system can proactively ask a consultant to provide answers to multiple challenge questions in order to minimize the probability of notifying a consultant each time a new challenge question is issued. Financial institutions may use different sets of challenge questions. However, the system may store the challenge questions issued by each financial institution. Eventually, the system may have all the possible challenge questions for a particular financial institution cached.

Some financial institutions have a one-time authentication mechanism, which allows a set of credentials to successfully authenticate once, but does not allow subsequent authentication with the same credentials. Accordingly, if a particular financial institution requires using a one-time authentication mechanism, the system may perform an authentication process with the consultant, as discussed above, each time the system attempts to retrieve the transaction records stored at the financial institution.

### Obtaining Transaction Data for Multiple Accounts and Households

Some consultants may have multiple accounts. For example a consultant may have a credit card from a first card issuer, through a first bank, and debit card from a second card issuer, through a second bank. Also for example, a consultant may have one or more accounts for online transactions, one or more accounts for large purchases, and one or more accounts for business-related purchases. Accordingly, query results and demographic data may be more accurate if consultants include all the accounts he or she holds or has access to, including accounts held by spouses and/or other household members.

Without receiving the transaction records for all accounts associated with each consultant and/or household, false positives and false negatives may arise. For the purpose of illustrating a clear example, assume that the system receives a query selecting consultant profiles that have executed ten or more transactions at a particular merchant within the past three months. Further assume that a consultant has only provided the credentials for a debit account at a first financial institution, but not a credit account at a second financial institution. Still further, assume that the consultant has executed transactions with the particular merchant, but using her credit account. Accordingly, the consultant's profile will not be selected by the query, because the system was unaware of the transactions made with the credit account. If a survey is sent to all consultants with profiles selected by the query, then the survey will not be sent to the consultant.

In another example, assume the system receives a query selecting consultant profiles that have not shopped at a particular merchant within a particular time period. Further assume that a consultant has only provided the credentials for a debit account at a first financial institution, but not a credit account at a second financial institution. Still further, assume that the consultant has executed transactions with the particular merchant using her credit account. Accordingly, the consultant's profile will be incorrectly selected by the query because the system was unaware of the transactions made with the credit account. If a survey is sent to all consultants with profiles selected by the query, then a survey will be incorrectly sent to the consultant.

In yet another example, separate accounts may be held by two consultants, which live in the same household. Thus, a query selecting consultant profiles with a certain income level per household, or spending level per household, may incorrectly include or exclude the two consultants because the income and transactions of both accounts may be assumed to be separate individual accounts.

Accordingly, the system may encourage a consultant to associate additional accounts to the consultant's profile by offering rewards. For example, the system may provide a cash-back reward that is proportional to the total sales amount of all transaction records that are retrieved. Thus, a consultant will increase her rewards by providing credentials for all accounts that she uses to process transactions.

Additionally or alternatively, the system may determine that two consultants are members of the same household based, at least in part, on connecting to the system with a computer that has the same internet protocol (“IP”) address. For example, if two consumers create separate consultant profiles that originate from the same IP address, then the system may associate the two consumers as members of the same household. Also for example, if two consultants consistently login to the system or make other requests, through one or more devices that share the same IP address, the system may associate the two consumers as members of the same household. Other properties, or property combinations, may also be used to determine if two or more consultant profiles should be associated: media access control (“MAC”) addresses, operating system identifiers, and/or geographic location information.

The system may determine whether a consultant has associated all his/her accounts based, at least in part, on the consultant's demographic profile, such as location and income level. The system may also determine whether the total spending amount of the transaction records retrieved is inline with the consultant's profile.

### Uploading Transaction Records

Consultants may upload statements which include transactions records. For example, consultant may download one or more statements. The statements may be stored in any format, e.g., Portable Document Format (“PDF”), comma separated value text, spreadsheet, or document, eXtensible Markup Language, image format, or any other document or interchange format.

The consultant may upload the statement to the system. For example, a consultant may upload a statement to the system through a browser running on the consultant's computer using hypertext transfer protocol, web services, or any other protocol, via an electronic device. In response to receiving the uploaded statement, the system may decompress, decrypt, and/or extract the uploaded document. The system may scrape transactions out of the document using regular expressions, optical character recognition, and/or any other method to extract strings and transactions in a statement. For example, a transaction description may have the following format, “26 MAY STARBUCKS #07897 Forest Hills N.Y. $14.22”. A regular expression may be used to extract the important attributes of the transaction, such as the date (26 May), the text description (Starbucks #07897 Forest Hills N.Y.) and the amount (14.22).

The system may strip the transactions of any personally identifiable information, and persistently store the stripped transaction records, without persistently storing the identifying information. Since personally identifiable information is not persistently stored and consultants are not required providing credentials, some consultants may be more willing to upload transaction records than provide credentials.

The system may send reminders to consultants, encouraging consultants to update transactions records by uploading additional and/or updated statements. For example, uploaded statements typically include a statement date. The system may send a reminder or notification to a consultant if the consultant has not uploaded a statement with a statement date within a certain time period. Additionally or alternatively, the system may send a consultant a reminder to upload a new statement if a certain amount of time has passed since the consultant last uploaded a statement.

### Assigning Transactions to Merchants and Categories

Transactions may be associated with merchants. Transactions may also be assigned to categories. Associations between transaction records and merchants, as well as associations between transaction records and categories, may be determined by a financial institution, a connector, another third party, and/or the system. Even if transactions are associated with a merchant and/or category by one other than the system, the system may still perform one or more routines to associate transaction records with merchants and/or categories to verify the associations are correct.

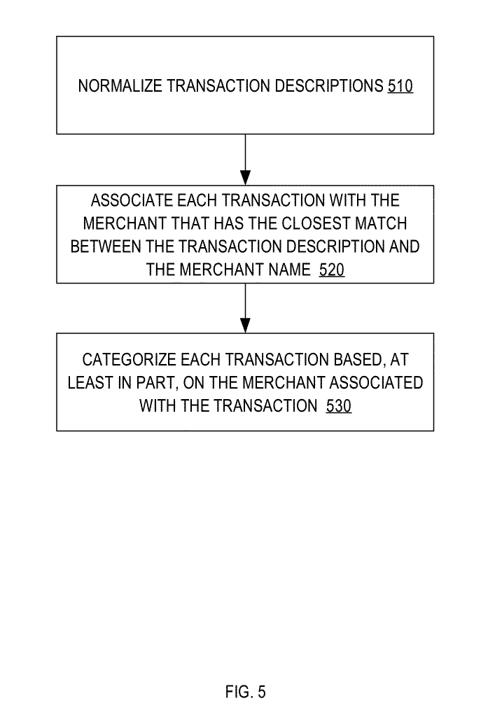

FIG. 5 illustrates a process for associating transaction records with merchants and categories, according to an embodiment. While FIG. 5 illustrates example steps according to an embodiment, other embodiments may omit, add to, reorder, and/or modify any of the steps shown. Referring now to FIG. 5, in step 510, the system normalizes transaction descriptions. For example, the system may remove the transaction identifiers and/or dates from each transaction using regular expressions or many other methods for parsing and editing strings.

In step 520, the system associates each transaction with the merchant that has the closest match between the transaction description and the merchant name. For example, an edit distance may be computed between each transaction and merchant in a merchant-name database based, at least in part, on the transaction's description and the merchant's name(s) in the merchant-name database. The system associates each transaction record with the merchant that has a name with the smallest edit distance. If a merchant has more than one name in the merchant-name database, the system still associates each transaction record with the merchant that has a name with the smallest edit distance

A merchant-name database may be collected and/or generated based, at least in part, on one or more publicly available sources. The merchant-name database may be generated as a pre-process. Additionally, the merchant-name database may be continually and/or regularly updated.

Edit distance can be computed using Hamming distance method, Levenshtein distance method, Damerau-Levenshtein distance method, Jaro-Winkler distance method, or any other distance algorithm. In an embodiment, the mismatch penalty is set to zero since transaction descriptions may include a merchant name, or a close variation of the merchant's name, surrounded by other text. Additionally or alternatively, other string matching algorithms may be used to determine which transactions to associate with which merchants.

Additionally or alternatively, the system may assign one or more transaction records to a merchant based, at least in part, on matching the transaction description in each transaction record with one or more sets of known patterns for one or more merchants, respectively. For purposes of illustrating a clear example, assume the system associates the regular expression “̂XYZ\'s Family Bakery\s\(\d+\. \d+\)$” with XYZ's Family Bakery, LLC. Also assume that the transaction description is “XYZ's Family Bakery (5.50)”. Accordingly, the transaction description will satisfy the regular expression and the system will determine that the transaction description and the regular expression are a match. In response to the system finding a match, the system may associate the transaction with XYZ's Family Bakery, LLC. The system may determine a match based on one or more character comparisons, regular expressions, and/or any other string matching algorithm.

In step 530, the system categorizes each transaction based, at least in part, on the merchant associated with the transaction. For example, each merchant in the merchant-name database may also be associated with one or more categories based, at least in part, on publicly available merchant-category mappings or data. Accordingly, each transaction may be associated with the same one or more categories that the associated merchant is associated with.

### Supplementing Demographic Data Based on Survey Responses

Some consultants may volunteer some demographic data. Additionally or alternatively, transaction records and survey responses may supplement a consultant's demographic data. For example, the system may determine that a particular consultant is a subscriber to a particular online streaming video service based, at least in part, on monthly transaction records to the particular service. However, a survey inquiring about preferred video content may reveal that the consumer prefers to watch comedies. Also for example, a consultant may indicate on a survey that the consultant owns a car that is a particular make and model. The system may store data in the consultant's profile that indicates the consultant owns a car with the particular make and model. Thereafter, the consultant may be asked to participate in a survey targeting those that own, or have owned, a car that is the particular make and model.

### Determining Geographic Location from Transaction Records

The geographic location for each consultant may be determined based, at least in part, on the transaction data associated with the consultant. While some consultants may input a geographic location, the system may determine the consultant's geographic location to validate the consultant's input.

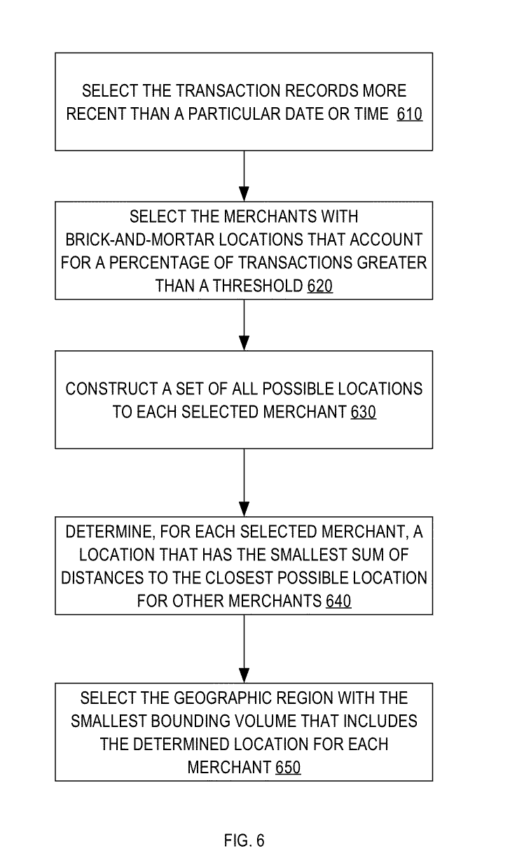

FIG. 6 illustrates a process for determining a consultant's geographic location based, at least in part, on transaction records, according to an embodiment. While FIG. 6 illustrates example steps according to an embodiment, other embodiments may omit, add to, reorder, and/or modify any of the steps shown. Referring now to FIG. 6, in step 610, the system selects the transaction records more recent than a particular date or time. For example, to determine where a consultant currently resides, the transaction records for the last six months may be selected.

In step 620, the system selects the merchants with brick-and-mortar locations that account for a particular percentage of transactions greater than a threshold. For example, each merchant that is associated with a selected transaction in step 610, which has at least one brick-and-mortar location, and is in the top quartile of the number of transactions, is selected. Accordingly, the merchants with brick-and-mortar locations, which are associated with more of the selected transactions than 75% of the other merchants also associated with the selected transactions, are selected. Additionally or alternatively, merchants that sell a significant fraction of their goods or services online may be ignored. Additionally, transactions determined not to be brick-and-mortar transactions may be ignored. A transaction may be determined to not be a brick-and-mortar transaction if the description indicates the transaction was made online, through mail-order/catalog, or using another method that is not face-to-face. Additionally or alternatively, transactions that are not retail transactions are ignored. A retail transaction may be a transaction in which the transaction description indicates the transaction was a sale of goods executed at a brick-and-mortar store for use or consumption rather than for resale. Additionally or alternatively a retail transaction may be a transaction that is associated with at least one of a particular set of merchants or categories.

In step 630, the system constructs a set of all possible locations to each selected merchant. Locations may be postal codes, zip codes, longitude and latitude coordinates, or any other code or system used to define a location. To demonstrate a clear example, assume that three merchants are selected in step 620: M1, M2, and M3. Further assume that M1 has five brick-and-mortar locations at Z1, Z5, Z9, Z100, and Z110; M2 has three brick-and-mortar locations at Z3, Z7, and Z105; and M3 has two brick-and-mortar locations at Z110 and Z120. Accordingly, in this example and in step 630, the brick-and-mortar locations for M1, M2, and M3 are selected.

In step 640, the system determines, for each selected merchant, a location that has the smallest sum of distances to the closest possible location for other merchants. Continuing with the above example, assume that the distance between locations is proportional to the square of the numeric difference of the number that follows the letter “Z” in each location. For example, the squared difference between locations Z110 and Z120 is 100, |110−120|²=100. Thus, the distance between Z110 and Z120 is proportional to 100. Also for example, the distance between Z5 and Z3 (|5−3|²=4) is proportionally the same as z5 to Z7 (|5−7|²=4).

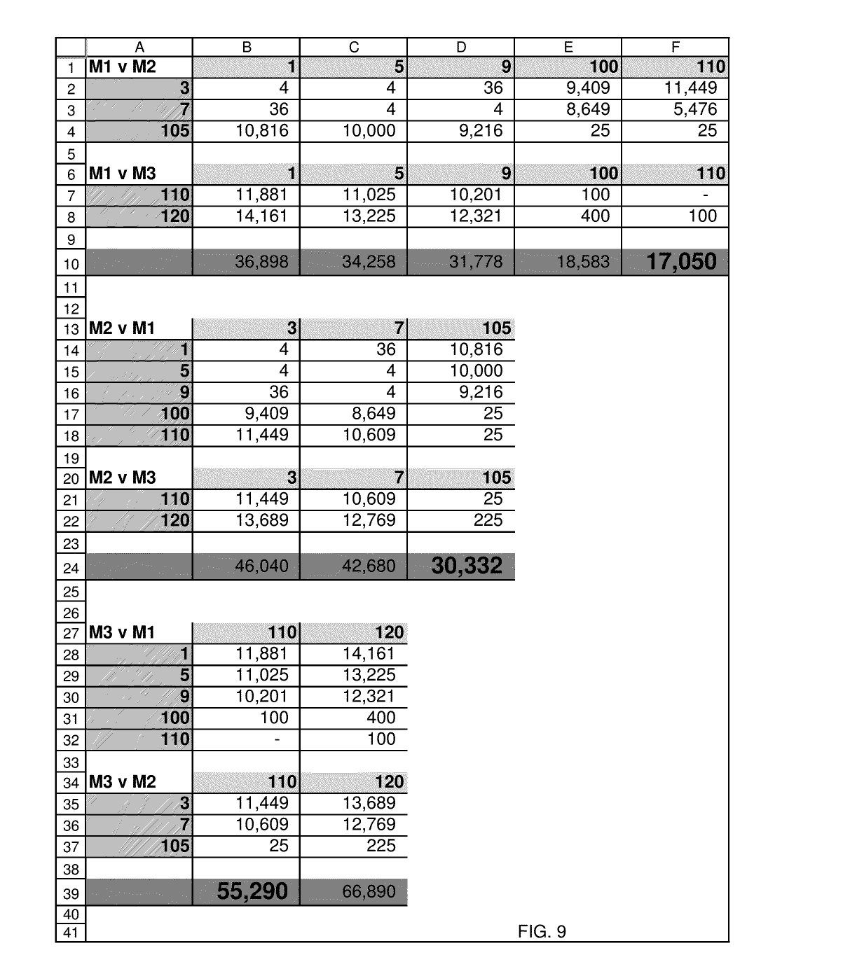

FIG. 9 is a spreadsheet illustrating the squared differences between the brick-and-mortar locations of each of the merchants M1, M2, and M3, as enumerated above, according to an embodiment. FIG. 9 consists of three sets of tables. The first set of tables (rows 1-10) enumerates the locations of M1 and the squared differences between M1's locations (rows 1 and 6, columns B through F) and each of M2's locations (rows 2-4, column A) and M3's locations (rows 7-8, column A). For example, cell B2 shows the squared difference between M1's location Z1 and M2's location Z3: |1−3|²=4. Row 10 is the sum of the squared differences for each of M1's locations and each of M2's and M3's locations. For example, cell F10 is 17,050, which is the sum of F2-F4 and F7-F8, 11,449+5,476+25+0+100=17,050. Cell F10 is also bolded, indicating that M1's Z110 location has the smallest sum of distances to the closest possible locations for M2 and M3.

Similarly, the second set of tables (rows 13-24) enumerates the locations of M2 and the squared differences between M2's locations (rows 13 and 20, columns B through D) and each of M1's locations (rows 14-18, column A) and M3's locations (rows 21-22, column A). For example, cell B14 shows the squared difference between M2's location Z3 and M1's location Z1: |3−1|²=4. Row 24 is the sum of the squared differences for each of M2's locations and each of M1's and M3's location. For example, cell D24 is 30,332, which is the sum of D14-D18 and D21-D22, 10,816+10,000+9,216+25+25+25+225=30,332. Cell D24 is also bolded, indicating that M2's Z105 location has the smallest sum of distances to the closest possible locations for M1 and M3.

Similarly, the third set of tables (rows 27-39) enumerates the locations of M3 and the squared differences between M3's locations (rows 27 and 34, columns B through C) and each of M1's locations (rows 28-32, column A) and M2's locations (rows 35-37, column A). For example, cell B28 shows the squared difference between M3's location Z110 and M1's location Z1: |110−1|²=11,881. Row 39 is the sum of the squared differences for each of M3's locations and each of M1's and M2's location. For example, cell B39 is 55,290, which is the sum of B28-B32 and B35-37, 11,881+11,025+10,201+100+0+11,449+10,609+25=55,290. Cell B39 is also bolded, indicating that M3's Z110 location has the smallest sum of distances to the closest possible locations for M1 and M2.

Thus, in this example, in step 640, M1's Z110 location, M2's Z105 location, and M3's Z110 location are determined to have the smallest sum of distances to the closest possible location for the other merchants.

In step 650, the system selects the geographic region with the smallest bounding location that includes the determined location for each merchant. Continuing with the example above, the smallest bounding location is selected that includes Z110 and Z105. In the current example, two locations are used since the location selected for M1 is the same location selected for M3. The system may use a publicly available bounding location hierarchy to determine the smallest bounding location in the hierarchy to associate with the consultant profile. For example, the bounding hierarchy may be geographical by country, province, state, county, city, zip code, or address. The smallest location in the hierarchy in the current example may therefore be a zip code. Additionally or alternatively, the system may use the bounding location to verify and/or update a location or bounding location already associated with the consultant profile.

Some transaction descriptions include a portion of the address or location that the transaction was executed in, such as the city. The system may verify and adjust the bounding location so that the address portion of the majority of such transactions is present in the deduced bounding location. Additionally or alternatively, the system may also present an interface to consultants whereby a consultant may assign the location of a particular transaction.

If a substantial portion (e.g., greater than 90%) of the transaction descriptions for a consultant include a single location, such as the city and state name, the system may assign the single location to the consultant. If no single location accounts for a substantial portion of the transactions, the system may assign the next level of a geographic hierarchy, such as a Core-based statistical area, Metropolitan Statistical area, or county, to the consultant. For purposes of illustrating a clear example, assume that a substantial portion of the consultant's transactions are split between two cities: Mountain View, Calif. and Sunnyvale, Calif. Also assume that Mountain View, Calif. and Sunnyvale, Calif. are both located solely, or least substantially, in Santa Clara County. The system may assign the consultant to the Santa Clara County, rather than either city, because both Mountain View, Calif. and Sunnyvale, Calif. are both located solely, or least substantially, in Santa Clara County and a substantial portion of the consultant's transactions are split between the two cities.

### Sampling Consultants

In response to a query, the system may sample or select consultant profiles based, at least in part, on any data associated with a consultant profile. For example, consultant profiles associated with geographically diverse cities, counties, or regions, which have a maximum level of consumer density and are within a particular distance from one or more retail stores may be sampled or selected for a query. Also for example, a query may select all consultant profiles that are associated with at least one transaction record, dated within the last month, and in which the transaction record is also associated with a particular merchant. In another example, consultant profiles associated with one or more demographics, such as age and/or income level, may be sampled or selected for a query. In yet another example, consultant profiles associated with geographically diverse cities and countries that have at least a threshold level of consumer density and are within a particular distance from one or more retail stores may be sampled or selected for a query.

In response to a query, the system may sample or select consultant profiles based, at least in part, on the number of consultant profiles already sampled or selected which belong to a similar demographic. For example, a query may specify that a maximum number of profiles should be sampled or selected associated with any given region, zip code, age, income level, credit score, and/or interests. Limiting the number of consultant profiles that should be sampled or selected from the same demographic may create redundancy, provide statistical significance, account for consultants that do not include, or option in, all the data possible in their profile, and/or increase anonymity.

In response to a query, the system may sample or select consultant profiles based, at least in part, on the size or population of a particular region. For example, more consultant profiles that are associated with larger city centers may be sampled or selected rather than consultant profiles associated with smaller city centers.

In response to a query, the system may return data derived from one or more consultant profiles, transaction records, or demographic data. For example, a query may request the average in-store purchase at a particular merchant per consultant determined to be within a particular income level or range. Also for example, a query may request the average amount each household spent on groceries during a particular time period. In another example, a query may request the average income level of a particular geographic area, in multiple age ranges. In still another example, a query may request the most popular locations to buy a commodity for a particular community. Other example queries may determine a merchant's total sales, number of unique consultants, and/or number of transactions over a particular period of time.

In an embodiment, manual interviews or diary surveys are not used. Instead the system may collect and analyze transaction data at smaller more frequently intervals, e.g., daily, instead of yearly. Furthermore, by not using manual interviews or diary surveys the system may reduce or eliminate recall bias present in interviews or diary based surveys.

### Forecasting

The system may receive a query to forecast aggregate statistics, such as the total sales or average transaction amount for a merchant. The system may first determine if the sample of consultants are representative of the desired population for the merchant. If the sample of consultants is representative of the desired population for the merchant, the aggregate statistics may be computed and returned.

Specifically, the system computes the aggregate statistics from a sample set of consultant profiles. The system compares publicly reported aggregate statistics to the computed aggregate statistics. If the two statistics track, the system may determine that the samples of consultants are representative of the desired population for the merchant. For some queries, this step may be performed offline. In response to receiving the query and determining that the sample of consultants are representative of the desired population, the system may compute and return the requested forecast aggregate statistics.

For example, a query may request the system to predict a merchant's performance. For purposes of illustrating a clear example, assume that according to the stored transaction records a merchant sold $100,000 in goods and services in its first fiscal year; $200,000 in goods and services its second fiscal year; and in the first three months of its third fiscal year the merchant sold $10,000, $15,000, and $20,000, in goods and services, respectively. Further assume that the merchant publically announced that it sold $10,000,000 in its first fiscal year and $22,000,000 in its second fiscal year. The system may determine that the two statistics track according to some threshold error amount, and that the sampled consultants are representative of the desired population for the merchant. Accordingly, the system may predict that the merchant sold $4,500,000 in goods and services in the first quarter of the merchant's third fiscal year. Furthermore, the system may predict that the merchant will sell $25,000 in goods and services in the fourth month of the third fiscal year. In the prior example, the system uses a linear tracking model and a linear regression model; but, the system may use on one or more other models, such as non-linear regression models, oscillators, and/or other statistical models with additional inputs, such as market or sector data.

### Correlating Data from External Sources

The system may store and correlate external data, such as real estate prices, securities or market data, public events calendars, traffic data, weather data, and marketing campaigns with query results. For purposes of illustrating a clear example, assume that severe snow storms plagued a particular city for a week, which managers claim affected consumer sales of goods. Further assume that an investor requests a report containing weekly sales figures over the past six months, which includes the particular week, for a particular merchant whom operates a store in the particular city. The generated report may indicate the weather conditions for each week to indicate whether sales were down during on the week affected by sever snow storms, and that sales were substantially higher the other weeks. Additionally, the inventors may request an additional report containing weekly sales figures over the same time period for the particular merchant's competitors in the particular city. These reports and other reports associated with external data may be used to determine whether other conditions affected sales or other financial activities.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

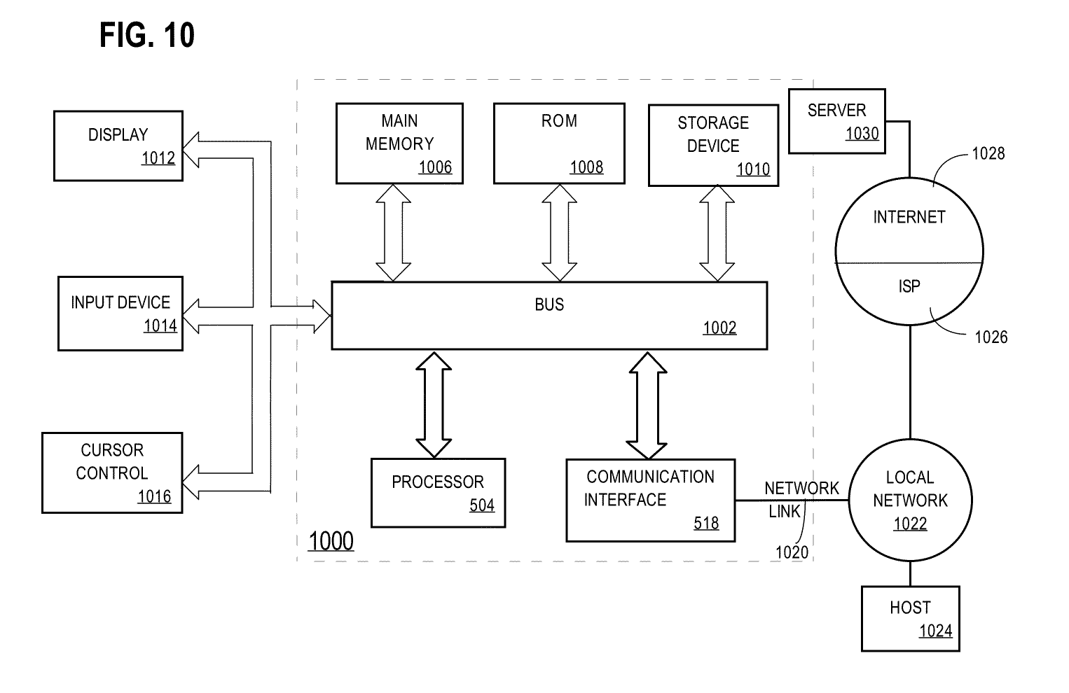

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
for each consultant of a plurality of consultants, a network-based service performing the steps of:
receiving, from the consultant, one or more consultant credentials for logging into one or more accounts, of the consultant, and retrieving transaction records from the one or more accounts of the consultant at one or more financial institutions of a plurality of financial institutions;
maintaining, on one or more storage devices associated with the network-based service, one or more electronic files that contain:
data for a profile comprising demographic data about the consultant;
the one or more consultant credentials of the consultant;
sending one or more requests for transaction records, which include at least one of the one or more consultant credentials, from the one or more accounts of the consultant at the one or more financial institutions;
in response to the one or more requests, receiving, in one or more electronic messages sent over a network to which the network-based service is connected, a plurality of transaction records that reflect past spending behavior of the consultant;
storing on the one or more storage devices, in association with the profile, past spending behavior information obtained by the network-based service from the plurality of transaction records;
wherein the network-based service further performs the steps of:
receiving a query;
identifying, from the profiles of the plurality of consultants, a set of matching profiles whose past spending behavior information satisfies one or more criteria; and
in response to the query, returning the set of matching profiles;
wherein the method is performed on one or more computing devices.

2. The method of claim 1, wherein:
the one or more requests to the plurality of financial institutions are made by one or more connectors;
the plurality of transaction records are received, at the network-based service, from the one or more connectors.

3. The method of claim 1, wherein:
the one or more consultant credentials, for each of the plurality of consultants, are not persistently stored at the network-based service;
the method comprising sending, for each consultant of the plurality of consultants, one or more new requests for transaction records, which do not include any of the one or more consultant credentials.

4. The method of claim 1 comprising:
determining that a particular transaction record of a particular consultant is associated with a particular merchant;
wherein the one or more criteria includes criteria relating to past spending behavior involving the particular merchant; and
determining that the one or more criteria are satisfied relative to the particular consultant based, at least in part, on determining that the particular transaction record is associated with the particular merchant.

5. The method of claim 4, wherein the particular transaction record includes a description, and the method further comprising:
determining an edit distance between text in the description of the particular transaction record and each merchant name in a repository of merchant names;
determining the particular transaction record is associated with the particular merchant based, at least in part, on the particular merchant having the merchant name that has the lowest edit distance from text in the description of the particular transaction record.

6. The method of claim 4, wherein:
the one or more criteria are satisfied relative to the particular consultant based, at least in part, on determining that the particular consultant has been a customer of the particular merchant;
the determination that the particular consultant has been a customer of the particular merchant is based, at least in part, on the particular transaction record being associated with the particular merchant.

7. The method of claim 6, wherein:
the one or more criteria are satisfied relative to the particular consultant based, at least in part, on determining that the particular consultant has ceased to shop at the particular merchant;
the determination that the particular consultant has ceased to shop at the particular merchant is based, at least in part, on:
determining that the particular consultant has not been a customer of the particular merchant based, at least in part, on the particular transaction record being associated with a first date or time that is before a particular date or time; and
determining that no other transaction records associated with the particular consultant and the particular merchant are associated with a second date or time that is subsequent to the first date or time.

8. The method of claim 7, wherein:
the particular transaction record is a first transaction record;
the one or more criteria are satisfied relative to the particular consultant based, at least in part, on determining that the particular consultant has started to shop at a competitor of the particular merchant;
the determination that the particular consultant has started to shop at a competitor of the particular merchant is based, at least in part, on:
determining that a second transaction record is associated with the competitor of the particular merchant; and
determining that the second transaction record is associated with a third date or time that is subsequent to the first date or time.

9. The method of claim 1, wherein:
a first profile is associated with a first consultant of the plurality of consultants;
a second profile is associated with a second consultant of the plurality of consultants; and
the method further comprises associating the first profile with the second profile, indicating that the first consultant and the second consultant are members of a particular household;
the one or more criteria relates to past spending behavior of one or more households;
the step of identifying the set of matching profiles whose past household spending behavior information satisfies the one or more criteria specified in the query.

10. The method of claim 1, wherein:
for each consultant of the plurality of consultants, further performing the steps of:
determining a location based, at least in part, on past spending behavior information associated with the profile; and
associating the location with the profile;
the one or more criteria relating to past spending behavior further include one or more locations;
the step of identifying the set of matching profiles further comprises identifying profiles that are associated with the one or more locations.

11. The method of claim 1 comprising, for each consultant of the plurality of consultants:
periodically receiving in one or more electronic messages sent over the network to which the network-based service is connected, a new plurality of transaction records that reflect past spending behavior of the consultant;
cumulatively storing on the one or more storage devices, in association with the profile, past spending behavior information obtained by the network-based service from the new plurality of transaction records.

12. One or more non-transitory computer-readable medium storing instructions which, when executed by one or more processors, cause performance of a method comprising:
for each consultant of a plurality of consultants, a network-based service performing the steps of:
receiving, from the consultant, one or more consultant credentials for logging into one or more accounts, of the consultant, and retrieving transaction records from one or more accounts of the consultant at one or more financial institutions of a plurality of financial institutions;
maintaining, on one or more storage devices associated with the network-based service, one or more electronic files that contain:
data for a profile comprising demographic data about the consultant;
the one or more consultant credentials of the consultant;
sending one or more requests for transaction records, which include at least one of the one or more consultant credentials, from the one or more accounts of the consultant at the one or more financial institutions;
in response to the one or more requests, receiving, in one or more electronic messages sent over a network to which the network-based service is connected, a plurality of transaction records that reflect past spending behavior of the consultant;
storing on the one or more storage devices, in association with the profile, past spending behavior information obtained by the network-based service from the plurality of transaction records;
wherein the network-based service further performs the steps of:
receiving a query;
identifying, from the profiles of the plurality of consultants, a set of matching profiles whose past spending behavior information satisfies one or more criteria; and
in response to the query, returning the set of matching profiles;
wherein the method is performed on one or more computing devices.

13. The one or more non-transitory computer-readable medium of claim 12, wherein:
the one or more requests to the plurality of financial institutions are made by one or more connectors;
the plurality of transaction records are received, at the network-based service, from the one or more connectors.

14. The one or more non-transitory computer-readable medium of claim 12, wherein:
the one or more consultant credentials, for each of the plurality of consultants, are not persistently stored at the network-based service;
the method comprising sending, for each consultant of the plurality of consultants, one or more new requests for transaction records, which do not include any of the one or more consultant credentials.

15. The one or more non-transitory computer-readable medium of claim 12, the method comprising:
determining that a particular transaction record of a particular consultant is associated with a particular merchant;
wherein the one or more criteria includes criteria relating to past spending behavior involving the particular merchant; and
determining that the one or more criteria are satisfied relative to the particular consultant based, at least in part, on determining that the particular transaction record is associated with the particular merchant.

16. The one or more non-transitory computer-readable medium of claim 15, wherein the particular transaction record includes a description, and the method further comprising:
determining an edit distance between text in the description of the particular transaction record and each merchant name in a repository of merchant names;
determining the particular transaction record is associated with the particular merchant based, at least in part, on the particular merchant having the merchant name that has the lowest edit distance from text in the description of the particular transaction record.

17. The one or more non-transitory computer-readable medium of claim 15, wherein:
the one or more criteria are satisfied relative to the particular consultant based, at least in part, on determining that the particular consultant has been a customer of the particular merchant;
the determination that the particular consultant has been a customer of the particular merchant is based, at least in part, on the particular transaction record being associated with the particular merchant.

18. The one or more non-transitory computer-readable medium of claim 17, wherein:
the one or more criteria are satisfied relative to the particular consultant based, at least in part, on determining that the particular consultant has ceased to shop at the particular merchant;
the determination that the particular consultant has ceased to shop at the particular merchant is based, at least in part, on:
determining that the particular consultant has not been a customer of the particular merchant based, at least in part, on the particular transaction record being associated with a first date or time that is before a particular date or time; and
determining that no other transaction records associated with the particular consultant and the particular merchant are associated with a second date or time that is subsequent to the first date or time.

19. The one or more non-transitory computer-readable medium of claim 18, wherein:
the particular transaction record is a first transaction record;
the one or more criteria are satisfied relative to the particular consultant based, at least in part, on determining that the particular consultant has started to shop at a competitor of the particular merchant;
the determination that the particular consultant has started to shop at a competitor of the particular merchant is based, at least in part, on:
determining that a second transaction record is associated with the competitor of the particular merchant; and
determining that the second transaction record is associated with a third date or time that is subsequent to the first date or time.

20. The one or more non-transitory computer-readable medium of claim 12, wherein:
a first profile is associated with a first consultant of the plurality of consultants;
a second profile is associated with a second consultant of the plurality of consultants; and
the method further comprises associating the first profile with the second profile, indicating that the first consultant and the second consultant are members of a particular household;
the one or more criteria relates to past spending behavior of one or more households;
the step of identifying the set of matching profiles whose past household spending behavior information satisfies the one or more criteria specified in the query.
